(19) United States
(12) Patent Application Publication
(10) Pub. No.: US 2019/0114688 A1
(43) Pub. Date: Apr. 18, 2019

(54) METHOD AND APPARATUS FOR PROVIDING INFORMATION ON OBJECT

(71) Applicant: Hyun Sung KO, Seoul (KR)

(72) Inventor: Hyun Sung KO, Seoul (KR)

(21) Appl. No.: 16/094,235

(22) PCT Filed: Apr. 12, 2017
(86) PCT No.: PCT/KR2017/003947

§ 371 Date: Oct. 17, 2018

(30) Foreign Application Priority Data
Apr. 19, 2016 (KR) 10-2016-0047494

(51) Int. Cl. G06Q 30/06; G06F 16/9535; G06F 16/955

(52) U.S. Cl. CPC G06Q 30/0631; G06Q 30/0625; G06F 16/955; G06F 16/9535

(57) ABSTRACT

The present invention relates to a method for providing information on an object by an object code management system, comprising: receiving a user instruction through a user interface of a display device; determining unique identification information of the object on the basis of the user instruction and searching for another object to be recommended by the object code management system on the basis of the object code matched with the unique identification information; and generating recommendation information on at least one of the determined unique identification information of the object and the another object.

### CROSS-REFERENCE TO RELATED APPLICATIONS

This application is a national phase of PCT/KR2017/003947 filed on Apr. 12, 2017 which claims priority under 35 U.S.C. § 119 to Korean Patent Application No. 10-2016-0047494, filed on Apr. 19, 2016, the contents of which are herein incorporated by reference in their entireties.

### BACKGROUND

### 1. Field

Exemplary embodiments of the present inventive concept relate to a method of object management system. More particularly, exemplary embodiments of the present inventive concept relate to a method of providing object information using object management system.

### 2. Description of the Related Art

Businessmen that produce or sell the current product or content are encouraged to use the Universal Product Code (UPC), European Article Number (EAN), International Standard Book Number (ISBN), Vehicle Identification Number (VIN), Stock Keeping Unit(SKU) to provide product information. However, there is a problem that the code is interpreted differently according to each company, or the product information is not specifically input or utilized due to the number only, and only the code is used. In addition, there is a problem that it cannot be used in combination. That is, there is a great restriction on the utilization such that no one is available, a fee is charged, only a single piece of information is registered in one code, or access is restricted by legal regulations.

In addition, currently, the apparel companies are providing product information on goods using the respective codes or inducing the purchase using the respective codes. However, the second buyer or the user cannot use the respective codes when they want to recommend the third preliminary buyer or other users by combining a plurality of products using the respective codes.

when users have to go through various brands when they want to shop a plurality of products, however the code for currently used products has a disadvantage that it cannot be universally used as a system limited to one brand and product classification. Moreover, most institutions that issue such codes are paid or unlisted and are not available to anyone.

In recent years when novel social networking services (SNS) have become popular, consumers such as entertainers, models and famous bloggers use products in addition to product producers and sellers, and upload use cases on-line to indirectly promote products. However, in order to accurately match the product when selling the product, there was a problem in specifying or identifying the product such as inputting or describing specific information such as product name, brand, color, and type. This is because a given code is usually accessible only to a specific vendor, making it virtually impossible for many to access the information. In addition, when the products are recommended in combination, the conventional method is accompanied by more troublesome work.

In this case, consumers have to purchase goods by accessing shopping malls created by different methods or policies in order to purchase a list of combined products, and the possibility of leakage of consumer information is high. The consumer who recommends the combination of the products can not verify the efficiency of the product recommendation, thereby causing a problem of reliability.

Also, even if there is a code that can update the logistics inventory and shipping status, there is no way to recommend the product using the code. For example, the concept of a unique number has existed, but it was limited in the system of re-evaluating and reselling products by inputting additional codes.

### SUMMARY

Exemplary embodiments of the present inventive concept provide a method and apparatus for producing, distributing, promoting, or selling goods, services, contents, And provides information for sales of the object by using the code of the object which can systematically and efficiently input all information from the resale to all the processes and enable the code to be entered or browsed by all the users.

Exemplary embodiments of the present inventive concept provide the second user to provide information for selling or recommending an object to another user using the code of the created object.

Exemplary embodiments of the present inventive concept accumulates and updates when a user inputs information to an object, and allows other users to provide relevant information when they want to view it.

In addition, unlike conventional UPC barcode codes, the present invention can maximize the efficiency of the latest information by including not only information input at the beginning of product production but also information input by other users in the code.

The purpose of the present inventive concept may not limited the above mentioned purpose. The purpose of the present inventive concept not mentioned above will become more apparent by following descriptions.

### BRIEF DESCRIPTION OF THE DRAWINGS

The above and other features and advantages of the present inventive concept will become more apparent by describing in detailed exemplary embodiments thereof with reference to the accompanying drawings, in which:

FIG. 1 illustrates a network configuration diagram for an object information providing method according to an exemplary embodiment of the present inventive concept.

FIG. 2 illustrates an embodiment of an object information server in system 100 according to the present invention.

FIG. 3 illustrates a flow chart showing a time-series flow in which users input an object code.

FIG. 4A is a data format that shows information input according to the code input order of FIG. 3.

FIG. 4B illustrates a check digit of a bar code including unique identification information matched with a code of FIG. 4A.

FIG. 5 illustrates an object code format according to the present invention.

FIG. 6 illustrate the code management system, according to the present invention.

FIG. 7 is a graph showing the relationship between an attribute of a code input by users in the code management system of the present invention.

FIG. 8 shows a case where a user inputs codes for a plurality of objects, according to the present invention.

FIG. 9 shows a web page for sale of goods.

FIG. 10 illustrates a display screen for providing object information according to an embodiment of the present invention.

FIG. 11 illustrates a screen for displaying object code information according to an embodiment of the present invention.

FIG. 12 is a flow chart for an object information providing method according to an embodiment of the present invention.

### DETAILED DESCRIPTION

The present inventive concept now will be described more fully hereinafter with reference to the accompanying drawings, in which exemplary embodiments of the present invention are shown. The present inventive concept may, however, be embodied in many different forms and should not be construed as limited to the exemplary embodiments set forth herein.

Rather, these exemplary embodiments are provided so that this disclosure will be thorough and complete, and will fully convey the scope of the present invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, the present inventive concept will be explained in detail with reference to the accompanying drawings.

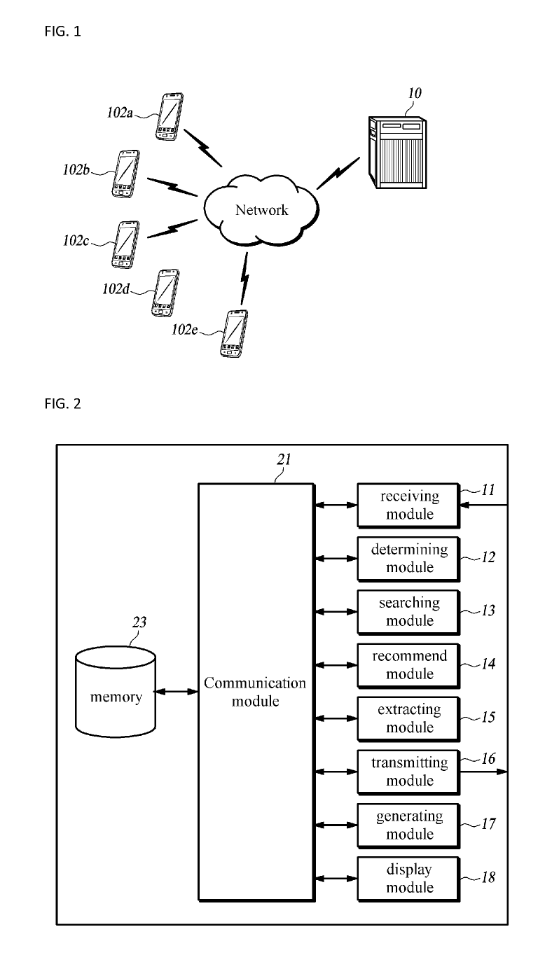

FIG. 1 illustrates a network configuration diagram for an object information providing method according to an exemplary embodiment of the present inventive concept. Referring to FIG. 1, the object code management system may include a server 10. The server 10 may receive an object code from a plurality of users 1, 2, 3, 4, 5 and store the code in the memory 23 (shown in FIG. 2). The memory 23 may be configured independently of the server 10 and operated through communication with the server 10 or integrated into the server 10.

In an exemplary embodiment, the object may be any tangible goods that are sold and movable and content that is intangible. For instance, the object may be unique item such as art, cultural property, creative article, or product. The object may also include intangible services such as tourist product. The object may also include a place such as restaurants, real estate, shopping malls, and historic site. In summary, the object means the tangible and intangible thing that is owned, purchased, or experienced by the user. In an exemplary embodiment, the user who produce, create, sell, or use an object may input code for the object, and all the history of the object may be stored and managed.

The users may be classified according to the user classification information. For instance, a user may be a creator who creates an object, a user may be a producer who manufactures an object, a user may be seller who sells an object if the object is a tangible product, or a user may be a distributor who distributes an object from a producer or another user. Also, the user may be a consumer who purchases, possesses, experiences an object, and inputs review information about an object.

According to the present invention, the code information may include the user identification information and the user behavior information to express various user input information. Referring to FIG. 1, a user 102a may input code information as a producer of an object, a user 102b may input code information as a distributor, a user 102c may input code information as a field-experienced person who has an direct experience in order to share experience, a user 102d may input code information as an customer who purchases or uses the object. Also, the user 102e may input code information as a potential purchaser who browses the stored code information and searches for the object information for curiosity, market research or future purchase purposes.

In an exemplary embodiment, the user 102a may input the object code by inputting information about the object at the time of initially creating or producing the object. In an exemplary embodiment, the user 102b may input the object code about distribute and sell the object, additional code information can be sequentially inputted. Also, the user 102c or 102d may input the object code about experience or purchase information using a smart phone, a mobile device, or a computer. Also, the object code about the history of browsing may update by the user 102e who browses the code of the object. The user 102e may request information on the entire code information while browsing the object, and the server 10 may provide the information. The server 10 may store code information as a predetermined format in the memory to be described later. Also, object recommendation information may be provided by the code management system of the present invention when the user 102e accesses a website for merchandise sales associated with the system of the present invention.

In the object code management system, the code may be inputted according to the temporal order. For instance, the code may be inputted when the object is created or after the user purchases and may be read by other users in the future.

It will be described in detail that an object code management method, a format of the code, and a method for providing object code information with reference to the following drawings.

FIG. 2 illustrates an embodiment of an object information server in system 100 according to the present invention. In an exemplary embodiment, referring FIG. 2, the server 10 may include a receiving module 11, a determining module 12, a searching module 13, a recommend module 14, an extracting module 15, a transmitting module 16, a generating and revising module 17 and a display module 18, a communication module 21 and a memory 23.

In an exemplary embodiment, referring FIG. 2, the server 10 may include a receiving module 11. The receiving module 11 may be configured to receive data over one or more networks via one or more network protocols. In some instances, the receiving module 11 may be configured to receive data from user devices 102a-102n, interfaced input devices, and other systems and entities via one or more communication methods, such as near field communication, cellular communication networks, local area networks, Bluetooth, etc. In some embodiments, the receiving module 11 may be comprised of multiple devices, such as different receiving devices for receiving data over different networks, such as a first receiving device for receiving data over near field communication and a second receiving device for receiving data via the Internet. The receiving module 11 may receive electronically transmitted data signals, where data may be superimposed or otherwise encoded on the data signal and decoded, parsed, read, or otherwise obtained via receipt of the data signal by the receiving module 11. In some instances, the receiving module 11 may include a parsing module for parsing the received data signal to obtain the data superimposed thereon. For example, the receiving module 11 may include a parser program configured to receive and transform the received data signal into usable input for the functions performed by the processing device to carry out the methods and systems described herein.

In an exemplary embodiment, the server 10 may also include a communication module 21. The communication module 21 may be configured to transmit data between modules, engines, databases, memories, and other components of the sever 10 for use in performing the functions discussed herein. The communication module 21 may be comprised of one or more communication types and utilize various communication methods for communications within a computing device. For example, the communication module 21 may be comprised of a bus, contact pin connectors, wires, etc. In some embodiments, the communication module 21 may also be configured to communicate between internal components of the server 10 and external components of the server 10, such as externally connected databases, display devices, input devices, etc. The server 10 may also include a processing device. The processing device may be configured to perform the functions of the server 10 discussed herein as will be apparent to persons having skill in the relevant art. In some embodiments, the processing device may include and/or be comprised of a plurality of engines and/or modules specially configured to perform one or more functions of the processing device, such as a determining module 12, searching module 13, recommend module 14, and extracting module 15, etc. As used herein, the term “module” may be software or hardware particularly programmed to receive an input, perform one or more processes using the input, and provides an output. The input, output, and processes performed by various modules will be apparent to one skilled in the art based upon the present disclosure.

In an exemplary embodiment, the server 10 may also include a memory 23. The memory 23 may be configured to store data for use by the server 10 in performing the functions discussed herein, such as user identification information and user behavior information, etc. The memory 23 may be configured to store data using suitable data formatting methods and schema and may be any suitable type of memory, such as read-only memory, random access memory, etc.

The memory 23 may include, for example, algorithms, communication protocols and standards, data formatting standards and protocols, program code for modules and application programs of the processing device, and other data that may be suitable for use by the server 10 in the performance of the functions disclosed herein as will be apparent to persons having skill in the relevant art. In some embodiments, the memory 23 may be comprised of or may otherwise include a relational database that utilizes structured query language for the storage, identification, modifying, updating, accessing, etc. of structured data sets stored therein.

In an exemplary embodiment, the memory 23 may be configured to store payment credentials provisioned thereto. In some instances, the memory 23 may include a trusted environment, Secure Element, or other secured data storage, which may be used to store the payment credentials. The memory 23 may also be configured to store key pairs generated by the server 10 and used for performing the functions discussed herein, such as key pairs used in the encryption and decryption of the payment credentials and key pairs used in the generation and verification of digital signatures.

In an exemplary embodiment, the server 10 may also include a transmitting module 16. The transmitting module 16 may be configured to transmit data over one or more networks via one or more network protocols. In some instances, the transmitting module 16 may be configured to transmit data to user devices 102a-102n and other entities via one or more communication methods, such as near field communication, the Internet, local area networks, Bluetooth, radio frequency, etc. In some embodiments, the transmitting module 16 may be comprised of multiple devices, such as different transmitting devices for transmitting data over different networks, such as a first transmitting device for transmitting data over a cellular communication network and a second transmitting device for transmitting data via the Internet. The transmitting module 16 may electronically transmit data signals that have data superimposed that may be parsed by a receiving computing device. In some instances, the transmitting module 16 may include one or more modules for superimposing, encoding, or otherwise formatting data into data signals suitable for transmission.

In an exemplary embodiment, the server 10 may include a searching module 13. The searching module 13 may be configured to execute queries on databases to identify information. The searching module 214 may receive one or more data values or query strings, and may execute a query string based thereon on an indicated database, such as the memory 23, to identify information stored therein. The searching module 13 may then output the identified information to an appropriate engine or module of the server 10 as necessary. The searching module 13 may, for example, execute a query on the memory 23 to identify object codes stored therein. The searching module 13 may be configured to search for a second object, based on the code of the first object matched with the unique identification information of the first object, wherein the search is based on link information to the first object, user identification information and user behavior information including user classification information, local information, time information.

In an exemplary embodiment, the server 10 may also include a generating and revisioning module 17. The generating and revisioning module 17 may be configured to generate data for use in performing the functions of the server 10 as discussed herein. The generating and revisioning module 17 may receive instructions as input, which may be used to generate data, and the generated data output to one or more engines or modules of the server 10. In some instances, the instructions input to the generating and revisioning module 17 may be accompanied by data for use therewith. For example, the generating and revisioning module 17 may be configured to generate an object codes when the user registers a new code. The registration of the code is usually done by the creator or producer. In an exemplary embodiment, the generating and revisioning module 17 may be configured to revision an object codes when users sequentially input code information. When inputting the code information, the generating and revisioning module 17 may revision and update the code information in a predetermined format described later.

In an exemplary embodiment, the server 10 may also include or be otherwise interfaced with a display module 18. The display module 18 may be internal to the server 10 or external to the server 10 and connected thereto via one or more connections (e.g., wired or wireless) for the transmission of data to and/or from. The display module 18 may be configured to display data to an operator of the server 10. The display module 18 may be any type of display suitable for displaying data as part of the functions discussed herein, such as a liquid crystal display, light emitting diode display, thin film transistor display, capacitive touch display, cathode ray tube display, light projection display, etc. The display module 18 may be configured to, for example, display machine-readable codes.

In an exemplary embodiment, the server 10 may also include a determining module 12. A determining module 12 may be configured to determine unique identification information of a first object based on the user command;

In an exemplary embodiment, the server 10 may also include a recommending module 14. A recommending module 14 may be configured to recommend a combination of two or more objects which are related to each other. By this, it is possible to provide partial information of an object to a user for selling an object and sharing object information. The recommending module may generate object recommendation information associate with at least one of the first object matched with the unique identification information and the second object,

In an exemplary embodiment, the server 10 may also include an extracting module 15. An extracting module may be configured to extract the service selling information based on the object recommend information and information for the first place from the object information matched with the unique identification information of the first object.

In an exemplary embodiment, the server 10 may also include the user management unit (not showing). The user management unit may manage user ID and user classification information. The user management unit may classify essentially input of the user detailed information and require the user to input the essential input. For example, if the user is a company, the user management unit may require the company to input company's name, classification of producible objects, storage, or distribution channel.

FIG. 2 may be included in the server 10 and may be operated independently of the server 10 as shown in FIG. 1.

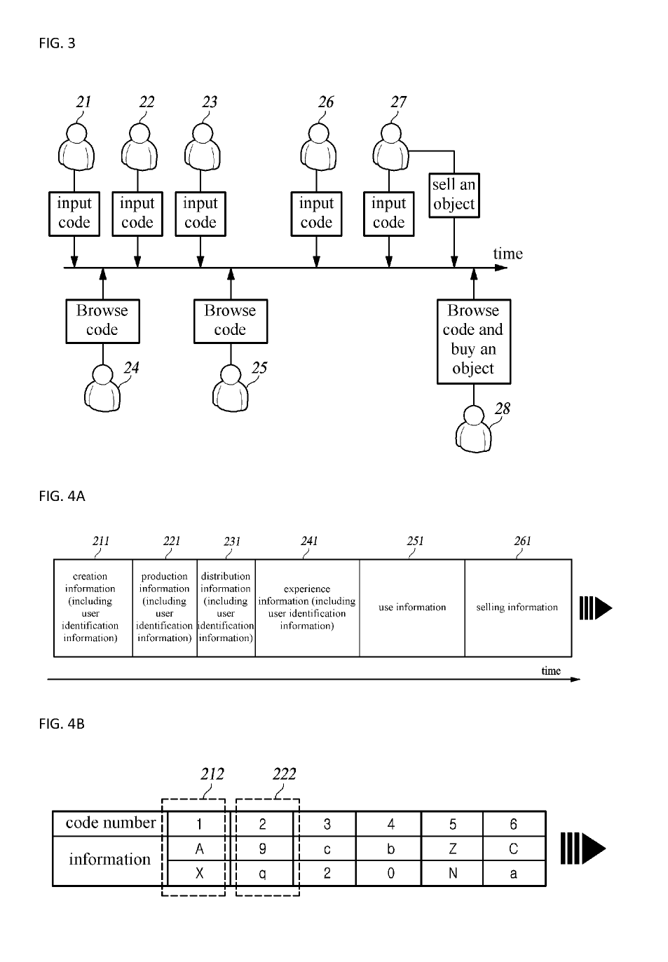

FIG. 3 illustrates a flow chart showing a time-series flow in which users input an object code.

In an exemplary embodiment, when the users sequentially input the code according to FIG. 3, the code contents are updated, and the machine readable code, such as a bar code or QR code, including object unique identification information can be updated. The unique identification information of the object is inherent information representative of the code of the object and can be confirmed or recognized through processes such as a barcode scanner and screen recognition. The contents of the object code are accumulated each time the users go through and the contents are stored and managed in the object management system. The unique identification information of the object may be a unique value that matches the code of the object and indicates the identity of the code of the object storing a large amount of information. If the object is a commercial product, a plurality of objects may be circulated with the same code according to a circulation process, and a plurality of codes may be separated and circulated to have codes of different contents.

FIG. 5 illustrates an object code format according to the present invention.

Referring FIG. 5, the object code format may include user identification information and user behavior information. For instance, the user identification information may include a user unique ID, user classification information, and user detailed information. The user identification information may be stored in the memory 23 of the server 10.

The user unique ID is for identify a user. The user unique ID may be inputted by the user when the user registers the user in the code management system. The user unique ID may be automatically generated, for example, when a user first accesses a code management system based on first access time, place, and user behavior information, etc.

The user classification information is about a user's current or future behavior information such as a user may be an object creator, a producer, a distributor, an experience user, a direct user, owner or a code viewer. In this specification, user may be classified to a producer, a distributor and a consumer. However, the scope of the invention is not limited thereto. For example, a producer may include at least one of an idea creator, a patent owner, a first owner, or a maker. A consumer may include a code viewer or who purchased an object and resells the purchased object. A distributor may include wholesaler and retailers as well as any intermediate medium between the producers and consumers of the goods.

User detailed information is about information necessary for production, distribution, use, consumption, maintenance or management of objects based on user classification information. User detailed information may include information of user name, email address, nationality, date of birth, the physical information necessary for put on, logos or photographs, means of payment or gender.

In an exemplary embodiment, for example, when the user classification information is a producer, the user detailed information is information related to the production of the object such as production place, quantity of production, quantity of production, and connection information to production information of other objects. For, example, connection information to production information of other objects is information about other objects relevant to the object, such as production information of other products sold by the same producer. For example, connection information to production information of other objects may include a site for browsing, a URL, connection information to a novel networking service, or connection information to another producer.

In an exemplary embodiment, for example, when the user classification information is a distributor, the user detailed information is information related to distribution of objects such as a distribution place, a quantity of distribution, a quantity of distribution, and connection information to distribution information of other objects. The connection information about the information Distribution of other objects may include a site, a URL, a novel for browsing code information of another object relevant to the object, connection information to networking services, or connection information to other distributors.

In an exemplary embodiment, for example, when the user classification information is a consumer, the user detailed information includes payment information for purchasing an object, delivery information, purchasing preference, purchase pattern information, and the like.

In an exemplary embodiment, the code for the input object can be browsed and inquired by the users, but a user detailed information may be viewed through authentication system through management system, or it can be viewed only by a limited number of users. That is, by allowing only a part of the user identification information to be read, the user identification information can be protected.

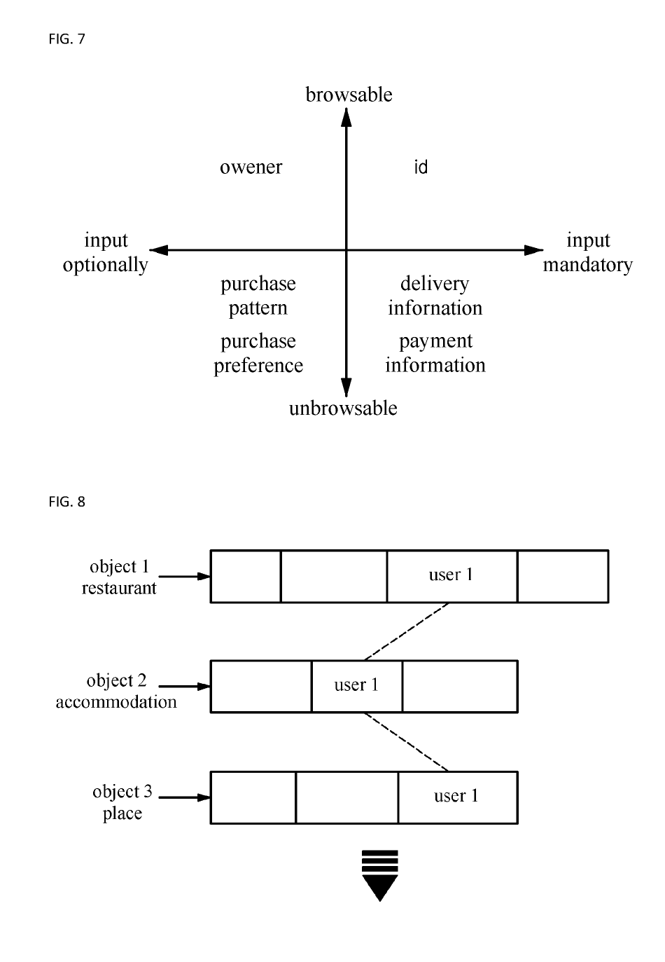

FIG. 7 is a graph showing the relationship between an attribute of a code input by users in the code management system of the present invention.

For example, when the user is a consumer, information such as payment information, delivery information, purchase preference, and purchase pattern included in the user detailed information is set to be unreadable by a general user. Information such as payment information and delivery information may be input mandatory and information such as purchase preference, and purchase pattern may be optionally inputted by the user, or the server can determine and store, based on the history purchased in the user behavior information. Also, the user unique ID for user identification and the user classification information can be browsed. The ID can be inputted mandatory for the first time when the user subscribes, and the others can be inputted optionally.

In summary, the user identification information may be classified whether mandatory or optional, and be managed for general user can view or not, based on the attributes of the information or the preset items. Also, only the information that can be read out among the user identification information can be provided to the general user by the display module 18 described above.

In an exemplary embodiment, the user behavior information is stored according to the input time sequential with the structured data format based on the user classification information.

When the user is a producer according to the classification information, the user behavior information may include attributes of the produced object, unique information (model number), production place, payment information, delivery information, production amount, production expected amount and the connection information. In addition, information on whether the production and sales target is an idea or a product can be inputted, and the photograph or video information of the production and sales target can be included. If there are many producers, profit structure contracts may be included. Further, it may further include information on the quantity that can be produced, the quantity that can be delivered, and the wholesale/retail price.

When the user is a distributor according to the classification information, the user behavior information may include information related to sales of the object, that is, sales price, sales quantity, distribution route, delivery information, and connection information for sale. That is, when the user is a distributor or a producer, the user behavior information may include similar contents.

When the user classification information is a consumer, the user behavior information includes the used object information, the usage time information, the use place information, and the late information as the fact that the user used the object or purchased fact information. If you have photos, videos, content, sites, etc., you may also include access information about them. The user can also introduce other objects related to the object, and can also include connection information to code for other objects.

FIG. 3 illustrates a flow chart showing a time-series flow in which users input an object code and FIG. 4A is a data format that shows information input according to the code input order of FIG. 3, according to the present invention.

Referring to FIG. 3, the creator 21 of the object (now the object is an idea) creates an object code and inputs the information, and then the object is produced by the producer 22, and the corresponding information can be inputted in the object code as code information in each case. In an exemplary embodiment, the creator 21 may input the idea of the object or the intangible property information and then the producer 22 may input the user identification information and the user behavior information of the object, for example, a unique number of an object, a model number, a kind, a production cost, unit price information,

Next, the distributor 23 who receives the object from the producer 22 may input the object code of distribution and selling. At this time, the input code may be user identification information and user behavior information of the distributor 23. That is, information necessary for distribution may include distribution sites, amounts of distribution, and access information of distribution channels when distribution is performed online.

The user 25 who has simply browsed the information about the object may input the code. For example, the user 25 who has browsed the sale site of the object provided by the distributor may input the object code of the browsing history of the object. The user 25 may be input as the code response information of the right object, retweet, a link to code access information. Thus, simply browsing the site about the object can be recorded as history and can be grasped as an interest. In addition, when the user 25, which is a code reader of the object, purchases the object, the code response information may further include purchase information and purchase path information.

The user 26 may then use the object and enter the code, e.g., if the object is a product and the experience use opportunity is given, the user 26 can input the explain information for the object, the review information as a code 241. In addition, there is link information that can be used to get usage information, such as linking photos and videos using objects. Also, link information for other objects related to the object can be further inputted. If you want to share experiences with similar objects and related services with experience objects, it may be possible to put link information to those. That is, as a costumer the user 26 may input the object code that may be used by a user who purchases the object or browses code information of the object, then the user 26 may get profits according to the marketing. By all the routes are stored, profit distribution and marketing path can become clear and the user may get profit according to the path.

In other words, a user performs a recommendation based on his or her interest such as a trip, a restaurant visiting, a beauty, a food, a cook, a sports, and a car. For example, he or she may introduce how to make up through a video and recommend beauty products, he or she may recommend other products that he or she has used while cooking such as spaghetti, sauces, cheeses, pans, etc., and may recommend the equipment and parts he or she has used while introducing how to repair a house repair car. Other users may purchase goods through these indirect routes.

If the behavior information of the user who input the code to the object is directly related to the profit, the information stored in the code may be analyzed and the contribution rate may be calculated, so that anyone who inputs the code may get the profit distribution according to the sales of the object accurately.

For example, when a graphic designer creates and sells a graphical product with a graphics company using software such as Photoshop, film production tools, 3D modeling software, etc., the interests may be clearly distributed to the designer and the company according to the step-by-step contribution information stored in an object code.

In an exemplary embodiment, a user 27 who is a consumer may browse an object code of a product which is inputted by a user 26 and buy the product. In that case, the code may include the purchase path that the user 27 has accessed the code and stored as the user behavior information. In an exemplary embodiment, the user 27 may input review of the object such as comment after use, place and time and it may be stored as user behavior information. In an exemplary embodiment, place may include a place of purchase or GPS location where user action information is entered for the object and time may include time of purchase or time when user action information is entered for the object.

As described above, not only the place where the user has purchased the product, but also all the location information about the production, distribution and use place can be inputted as the user behavior information. By inputting the location information, it becomes easy to track the location of the object, grasp the quantity, preference area, and estimate expected area.

On the other hand, the user 27 can resell the purchased object. In this case, when the object is sold on-line, contents for sale can be input as the code. At this time, the user behavior information is information for selling the pre-owned object, and may further include payment information, call information, price, and sales path.

Next, the user 28 who has browsed the code may purchase the used object, and the corresponding information can also be stored as the code of the object. If another user (not shown) browses such a series of contents, it may be an opportunity to check the popularity or the distribution path of the object.

On the other hand, whenever a code is inputted, the input path is stored as user behavior information. For example, in the case of a user who purchases an object, the user behavior information may include access information that a user has accessed for purchase. The access information may include that whether the user purchased the object by browsing the object code inputted by a producer 22, by a distributor 23 or by an experience user 26. Thus, a weight can be given to one of a producer 22, a distributor 23 or an experience user 26 who input codes related to purchase based on the access information. By assigning weights, it is possible to accurately grasp the sales route of the object, the marketing power or the market share, and may be utilized the profit distribution.

When the user is a consumer according to the classification information, the user behavior information includes information that the user has used the object or the user has bought the object such as the usage time information, the use place information, and the reviews of the object. In addition, if the user behavior information includes photos, videos, content, sites, etc., it may include access information about them. The user may also introduce other objects related to the object, and may also include connection information to code for other objects.

In an exemplary embodiment, the unique identification information of the code is updated so as to match with each other when the content is changed. Referring to FIG. 4A, there are six entry numbers for matching user behavior event in FIG. 4B, and the numbering is correspondingly increased each time code contents are increased. The entity 212 for the number 1 is generated when the code content 211 for the creation information is generated and the entity 222 is generated when the code content 221 is generated. In FIG. 4B, user identification information and the user behavior information are combined to form two digits such as “Ax” and “9q”. For example, the entity 212 may be represented as ‘A’ for the user's unique ID, and may be configured to represent some of the user behavior information as ‘q’ through computation or encryption.

In an exemplary embodiment, information input to a code can be encrypted as a symbol of a limited data size. For example, in A-Z, a-z, and 0-9, each digit can have 62 different meanings, and can be set so that their characteristics or characteristics are easily identified. For example, objects, such as goods, real estate, human experience, or intangible services of tangible goods, can be classified based on the characteristics of an object.

For example, in the case of tangible goods, it may be set to start with A, followed by setting ‘clothing’ to start with ‘1’, and then to top or bottom. You may express a thing as a digit. As another example, if the real estate is classified as ‘B’, it may be narrowed down to a category of ‘1’ for whether sub-classification is a hotel or a restaurant. In an exemplary embodiment, in the case of intangibles, it may be set to start with ‘C’. By giving meaning to each of the 62 symbols for each space in this form, it is possible to set information such as the producer ID, country information, attribute, production year, color, combination, with this limited data size. According to this, you may input the meaning of a combination close to infinity.

In the code management system according to the present invention, a record of a code may be assigned to each classification, and each record may indicate a hierarchical relationship.

That is, according to the present invention, records in one code of the object may be formed or updated to correspond to the code content of the object. A code corresponding to the unique record is searched in the database of the object management system.

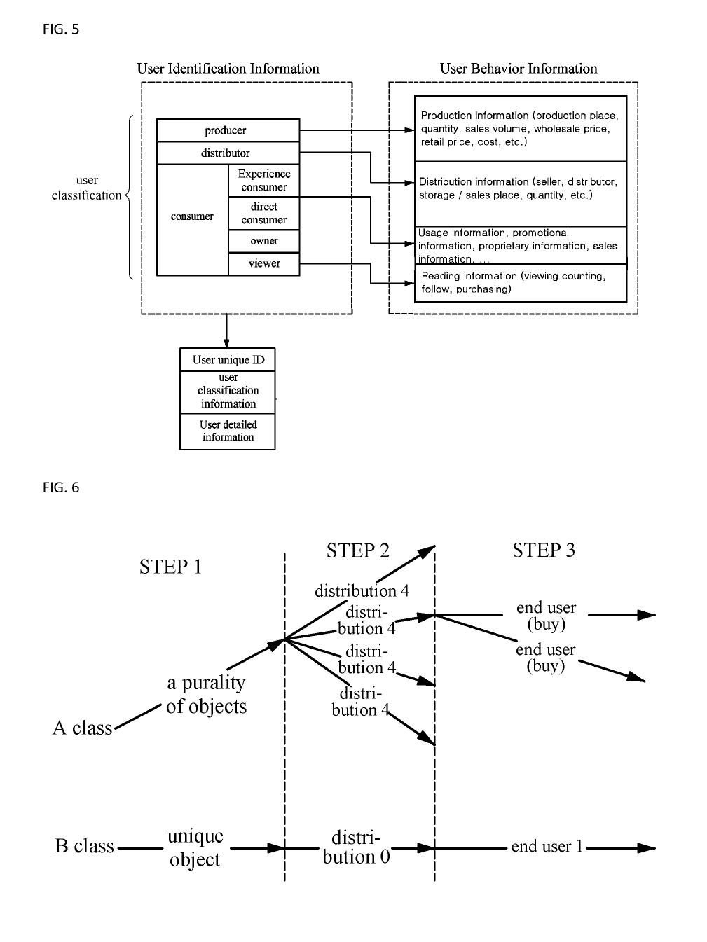

Next, referring to FIG. 6, the code management system according to the characteristics of the object will be described.

As described above, the object that is the object of the code management system of the present invention can be a product or content (hereinafter referred to as “A class”) that can be sold or moved in a plurality, and can be a unique real estate, a handicraft or an article having personality such as a cultural property, a creative article (hereinafter referred to as a “B class”). FIG. 6 shows the distribution paths of A and B according to the time. In the case of A, which is produced or sold as a plurality of objects, a plurality of objects can be allocated with a common code at the same time of production. If a plurality of pieces are separated in the distribution process (distribution 1 to distribution 4), codes corresponding to distribution 1 to distribution 4 are inputted respectively. In the final step (in step 3) where the end user may purchase a single object, unique code is created. That is, in the case of a plurality of industrial products, a plurality of objects can share a common code up to the production and distribution steps 1 and 2. Since the code of one object is stored step by step and the code is completed by the end user inputting a code of the object, the contents related to the object can be tracked even if the corresponding object is lost or discarded.

In an exemplary embodiment, in the case of the B class, there is a property that a single code is inputted and maintained for one object from the production. In addition, the corresponding code is consistently formed or updated correspondingly.

In an exemplary embodiment, a code may be shared by a plurality of objects by some users according to the individuality or unity of the objects. FIG. 6, a code is inputted by the producer of the first stage or the distributor of the second stage.

FIG. 8 shows a case where a user inputs codes for objects. After user 1 has visited a restaurant which is an object 1, the user 1 inputs the related information into his or her social networking service. Later, the user 2 goes to the accommodation which is an object 2 and goes to a place where the object 3 is, and watch the performance. In this way, the behavior information of user 1 may be sequentially inputted to different object codes with a time difference, and all of the objects include position information and are located close to each other. A user 2 may browse the combination of the social networking services of the user 1 at once, or the user 2 who has browsed one of the objects 1, 2, and 3 may use the code information of the user 1. That is, not a single product or service business, but a combination of travel courses are combined and browsed. When the information contained in the user identification information and the user behavior information stored in the object is related to another object, for example, when connection information to another object is included, the combined experience can be recommended or suggested.

In an exemplary embodiment, when the object has location information, travel course information combining objects 1, 2, and 3 based on similarity may be recommended. Similarity may be that some of the users included in the recommendation information of an object are common, or the location information is similar, the proximity, or the time information in which the code is inputted are input in close proximity.

In an exemplary embodiment, when a recommender recommends or provides supplementary explanation, for example, when a reason for recommending a certain movie theater is written, if the viewer of the movie the viewer views the reason, it can find an improvement point, which may affect the business improvement.

In an exemplary embodiment, according to the present invention, consumers associate and refer to objects such as a recommendation of a combination of goods and a matching of a plurality of goods, so that the codes for the objects are related. By this, unexpected effects occur. For example, the ability of the consumers who entered the code may be evaluated, and the effect of new job creation can also arise. In this case, the potential demand can be grasped for the products whose production has been stopped, and the economy can be revitalized as reproduction and resale.

In an exemplary embodiment, when a user wants to buy or sell a house in a real estate transaction, he or she can input information related to the house, request a code, or give a code to the system. In this case, it is possible to reduce the waste of time and money, such as the reduction of the real estate brokerage fee or the unnecessary movement of the sellers by providing contents such as linked photographs or moving images or virtual reality.

In addition, it is possible to prevent overlapping reservation in advance by updating the reservation status in a real-time form in the case of an object being such as a real estate, a hotel, a restaurant, and the like.

In the past, only the product of the type has the manufacturer linking the identification number. However, the present invention can be commercialized even in the case of the intangible including the temporal concept such as travel information.

In an exemplary embodiment, if the object is an intangible service, it may include information for selling the service as recommendation information of the object, and may extract, from the code information of the object matched with the unique identification information of the searched object, and display the information through the display device of the user, so that the service can be recommended.

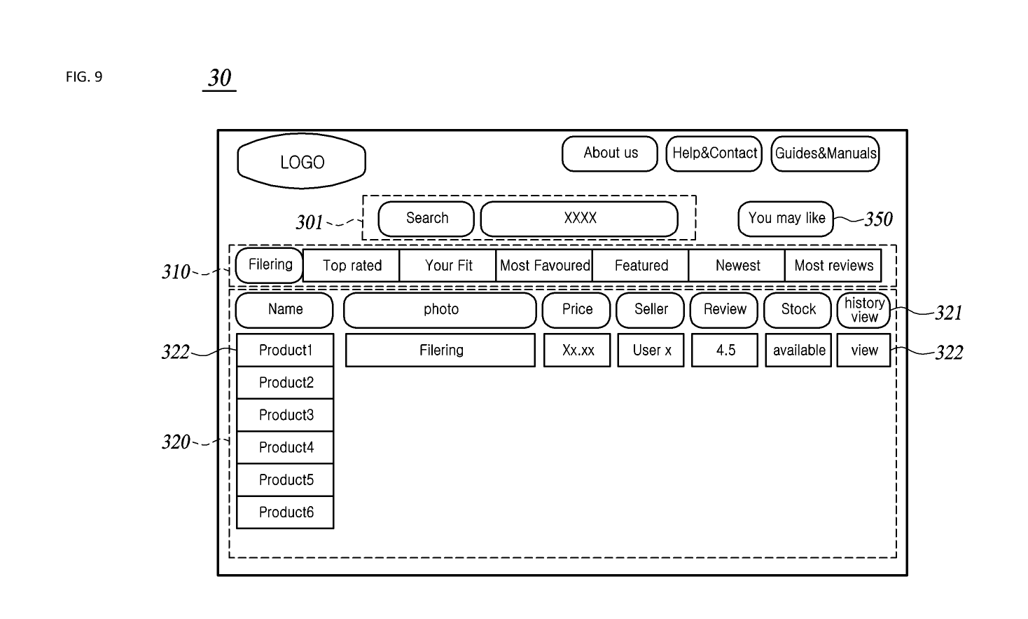

In an exemplary embodiment, if the object is related to the place as shown in FIG. 9, the recommendation information of the object is information for promoting or sharing the place, and the code of the object Information about the place or another place may be extracted from the information, and the extracted information may be displayed on the display device of the user, so that a recommendation may be made for a combination of a travel destination or a travel route. In FIG. 9, after information is input to the code for the object 1 used by the user 1, codes are sequentially input for the objects 2 and 3 within a near time.

For example, the objects 1, 2, and 3 are related to the code inputted in the time zone close by the user 1, and tracking the object code matching the unique identification information of the user 1 completes the travel route of the user. It is possible to search for other objects 2 and 3 that are judged to be related to the object 1, and combine them to provide them as recommendation information. Referring to FIG. 9, it is understand that objects 1, 2 and 3 have a relationship of user and input time or local proximity.

In an exemplary embodiment, when a user inputs code information to one object, information related to another object 2 may be connected, and it may be determined that there is a relation between the objects.

In an exemplary embodiment, if at least one of the user identification information or the user action information is related to another object related to sales, the user may be determined as another object to be recommended and may be provided together as recommendation information. At this time, And recommendation information of other objects can be generated based on the object code matched with the unique identification information.

FIG. 9 shows a web page for sale of goods.

When a user inputs a query into the search interface 301 to search for a product, a result 320 of a product related to the query may be displayed. A filtering option 310 regarding the sorting of the search results 320 may also be provided. The search result 320 includes a name of a product, a photo, a price, a seller, a review, a stock, and a history view of the present invention.

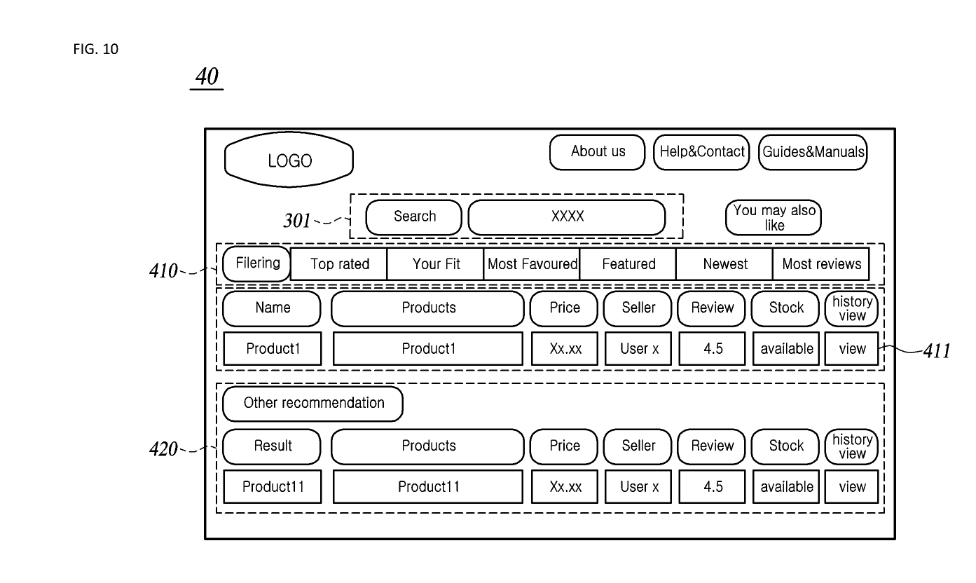

In an exemplary embodiment, an interface 350 for object recommendation can be provided. The interface 350 is an interface for searching for and recommending an object that the user likes based on the user information stored in the user management unit and the query inputted by the user, and the result may be displayed as shown in FIG. 10. Since user identification information, user classification information, and the like are stored in the user management unit, and the user has previously stored the purchased product, the retrieved product, and the reaction information, the user's taste and purchase pattern are combined with the query which may be used to search for objects. That is, when the user selects the interface 350 for object recommendation, the user may search for an object to be recommended to the user based on the user information and the user's previously query information stored in the object code management system. The recommended object may be more than one.

In an exemplary embodiment, when the user selects a specific product1 322, the system may determine the unique identification information of the object based on the user command and inquire detailed information of the object. In addition to the selected object 322, new recommendation information can be generated based on the code information of the object matched with the unique identification information of the object product1. That is, since a product purchased, a product retrieved, and a response information of a user are stored in the code management system, it is possible to further search other objects to be recommended in the code management system by combining with the query. If there is no other object, only object recommendation information including detailed information of product1 will be displayed (not shown), and if there are other objects, two objects can be displayed as recommendation information as shown in FIG. 10. That is, even if only one product, product1, is selected by the user, unique identification information of the searched object and recommendation information for at least one of the other objects are generated and displayed to satisfy the user's curiosity.

Referring to FIG. 10, the user may select the interface 322 for the code of the object. In this case, the user determines the unique identification information of the object product1 matching the interface 322 and the code information of the object matched with the unique identification information of the determined object may be loaded and displayed.

In an exemplary embodiment, when a website for selling a commodity is associated with the code management system of the present invention, it is possible to predicting what the user desires based on pre-stored user information and recommend products. When a user orders a query to input a query or selects a product, the user can recommend the product based on the stored user information and the user input.

The recommendation information of the object according to the present invention includes information for selling the object, extracts information for selling the object from the code information of the object matched with the unique identification information of the object, Display through the display device, thereby enhancing the user experience.

FIG. 10 illustrates a display screen for providing object information according to an embodiment of the present invention. In FIG. 10, the recommendation information 410 and 420 relating to two objects (product1 and product11) are provided. Referring to FIG. 10, the user may select the object product1, the code information of the object is searched to determine another object product11 as an object to be recommended which is related to the object product1. The recommendation information of the object product11 may be further generated based on the object code matched with the unique identification information. In FIG. 10, since the seller of the object product1 is the same to the seller of the object product11 and considering the size and stock availability, product11 is also determined to be related to product1 and generates and provides recommendation information to the user. The recommendation information is information for sale and can be extracted and generated from the code information of the object. That is, a unit of code of an object is a combination of user identification information and user behavior information input from users, and information about prices, sellers, inquiries, and inventory amounts related to sales of the information is extracted and the recommendation information is generated.

On the other hand, the recommendation information may also provide a browsing interface 411 so that the user can browse the code.

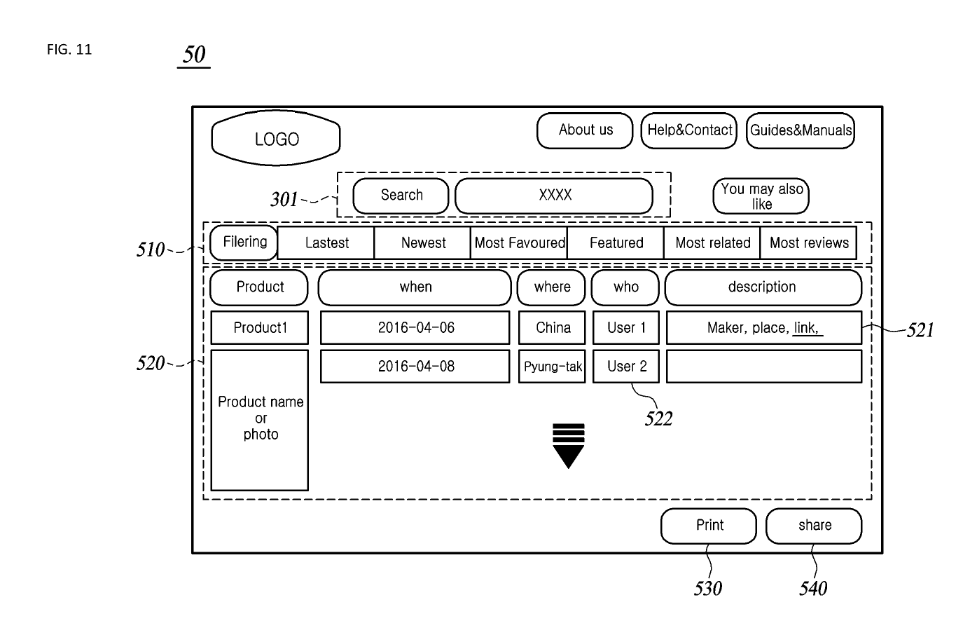

FIG. 11 illustrates a screen for displaying object code information according to an embodiment of the present invention.

In the case of selecting the interface 322 in FIG. 9 and the interface 411 in FIG. 10 for code browsing of an object, code information of an object matched with unique identification information of the corresponding object is loaded, and sales information. It is possible to display information that can be viewed as information useful for sharing. As described above, the code information of the present invention can display combinations of user identification information and user behavior information, which are input in a time series sequence, as shown in FIG. 11. The user may print (530) that information or share (540) it over the network.

On the other hand, the user can select the user user2 522 or the user content information 511 that has entered the code among the code information and can see the detailed contents. On the other hand, when the user selects the interfaces 521 and 522 for selecting a part of the code of the object, code information on other objects related to the code part of the selected object is retrieved, and object recommendation information is further generated based on the retrieved code information. When the user selects user 2, if the user 2 who inputs the code is a distributor, user2 may sell another product that is related to the user identification information stored in the system while the user 2 is selling the product and the recommendation information of another object may be generated.

That is, according to the present invention, even if a user does not select a recommended interface and selects a code part of an object or an object, it searches for another object which may the user likes based on the selected content and the identification information.

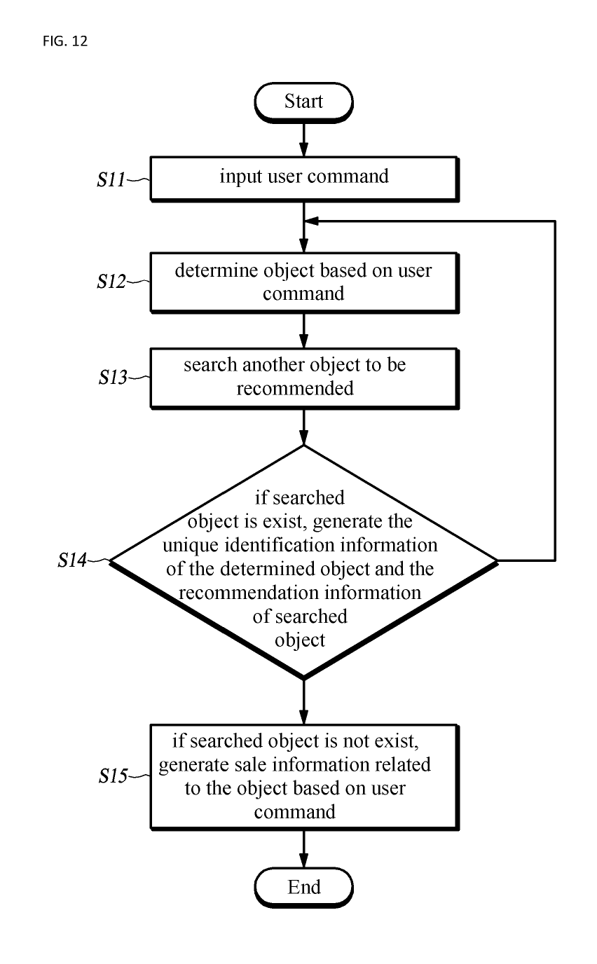

FIG. 12 is a flow chart for an object information providing method according to an embodiment of the present invention, and may be executed in a system or the like that executes a web site linked with a server or an object management system of an object management system.

The method of the present inventive concept starts from a step S11. In step S11, a user command is input through the user interface of the display device. In an exemplary embodiment, the user command may be an object selection, an object reference, or a selection of a portion of the object code.

In a step of S12, the unique identification information of the object may be determined based on the user command. For example, when the user command is the selection of the object, the unique identification information of the object may be determined. The unique identification information of the object is information representing the code of the object, and updated whenever the object code is inputted or updated.

In a step of S13, the object code management system may search for another object to be recommended based on the code of the object matched with the unique identification information of the object. Each of the unique identification information of the object is stored in correspondence with the code information, and the corresponding code information is searched to further search for other relevant objects. That is, when at least one of the user identification information or the user behavior information included in the code of the object may be related to another object to be sold, it is determined as another object to be recommended.

In a step of S14, both the unique identification information of the determined object and the recommendation information on the other object may be generated. Then, the recommendation information may be displayed on the display device of the user.

In a step of S15, if there is no other object, the recommendation information related to the sale may be generated from the object code information matched with the unique identification information of the determined object.

The scope of the present invention can be applied not only to a server provided with an object management system but also to a user display apparatus in which recommendation information of the present invention is displayed. In this case, the display device may include a user interface, a communication unit, a display unit, and the like, which are connected to the code management system through a network and receive user commands.

The display device can be a notebook, a tablet computer, a smart phone, a mobile phone, and the like.

The communication unit requests the object code management system to search for the unique identification information of the object on the basis of the user command. The object code management system searches for the object identification information, which is generated based on the code of the object, from the object code management system. When the object code management system searches another object to be recommended based on the code of the object matched with the unique identification information of the searched object, the communication unit further receives the recommendation information of the other object based on the code of the other object.

The display unit may include any display such as an LCD, LED, PDP, VFD, TBD, SPD, touch screen, etc. for displaying received object recommendation information.

The scope of the present invention can also be applied to a program for the code information providing method of the present invention, a computer readable recording medium on which the program is recorded, an arbitrary electronic apparatus capable of executing the program.

The foregoing is illustrative of the present inventive concept and is not to be construed as limiting thereof. Although a few exemplary embodiments of the present inventive concept have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific exemplary embodiments disclosed, and that modifications to the disclosed exemplary embodiments, as well as other exemplary embodiments, are intended to be included within the scope of the appended claims. The present inventive concept is defined by the following claims, with equivalents of the claims to be included therein. In addition, the various technical features in the present inventive concept may be implemented by hardware, software, or a combination of hardware and software. Accordingly, a specific part of the method of analyzing the hazard of the control software driving system may be formed as at least one of computer programs executable by a general purpose microprocessor, a dedicated microprocessor and a microcontroller. The computer program according to the present exemplary embodiments may be stored in one of storing mediums including a non-volatile memory such as EPROM, EEPROM and a flash memory device, an internal hard disk and a detachable disk, a magnetic disk, a magnetooptic disk and a CD disk. In addition, the program codes may be written in an assembly language or a machine language. The program codes may be transmitted by one of transmitting mediums including an electric wiring, a cable, and an optical fiber and so on.

1-15. (canceled)

16. A method for providing object information by an object code management device, the method comprising:
receiving, by a receiving module of a computing device, a user command through a user device;
determining, by a determining module of the computing device, unique identification information of a first object based on the user command;
searching for a second object, by a searching module of the computing device, based on an object code of the first object matched with the unique identification information of the first object, wherein the search is based on link information to the first object, user identification information and user behavior information including user classification information, local information, and time information ; and
generating, by a recommend module of the computing device, object recommendation information associated with at least one of the first object matched with the unique identification information and the second object,
wherein the object code is sequentially inputted from at least one user, and the inputted object code includes a combination of user identification information and user behavior information for at least one user.

17. The method of claim 16, wherein the user command includes at least one of object recommend command, object selection command and object code search command.

18. The method of claim 17, further comprising:
when user command is object recommend command, searching for a second object, by a searching module of the computing device, based on the stored user information and inputted search information by the user.

19. The method of claim 17, further comprising:
when the user command is object selection command, generating, by a recommend module of the computing device, recommendation information associated with the second object.

20. The method of claim 17, wherein:
when the user command is object code search command, searching for a third object, by a searching module of the computing device, based on the second object; and
the method further comprises:
generating, by a recommend module of the computing device, recommendation information associated with the third object,

21. The method of claim 16, wherein the object recommend information includes object selling information, and
the method further comprises:
electronically transmitting, by transmitting module of the computing device, the object selling information.

22. The method of claim 21, wherein:
at least one of the user identification information or the user behavior information includes information related to sales, and
the method further comprises:
extracting, by a extracting module of the computing device, the information as sales information of an object.

23. The method of claim 16, wherein:
the object recommend information includes information for object selling, when user identification information or user behavior information includes a fourth object code information, and
the method further comprises determining, by the determining module of the computing device, a fourth object as a recommend object.

24. The method of claim 23, further comprising:
generating, by a recommend module of the computing device, recommendation information associated with the fourth object.

25. The method of claim 16, wherein object identification information is updated as the object code is updated.

26. The method of claim 16, wherein:
when the first object is associated with intangible service, the object recommend information includes the service selling information, and
the method further comprises:
extracting, by a extracting module of the computing device, the service selling information based on the object recommend information; and
displaying, by display module, the service selling information electronically transmitting, by transmitting module of the computing device, the extracted information.

27. The method of claim 16, wherein:
when the first object is associated with a first place, the object recommend information includes promotion information of the first place or explaining information of the first place, and
the method further comprises:
extracting, by a extracting module of the computing device, information for the first place from object information matched with the unique identification information of the first object; and
electronically transmitting, by transmitting module of the computing device, the extracted information.

28. The method of claim 27, further comprising:
extracting, by the extracting module of the computing device, information for a second place from the object information matched with the unique identification information of the first object;
searching for a second place, by a searching module of the computing device, based on the information of the first object, wherein the search is based on user identification information, location of the first place and time information of inputting the first object;
extracting, by the extracting module of the computing device, information for the second place; and
electronically transmitting, by transmitting module of the computing device, the extracted information.

29. The method of claim 16, further comprising:
when the user command is object code search command,
electronically transmitting, by transmitting module of the computing device, first object information.
